(19) United States
(12) Patent Application Publication
(10) Pub. No.: US 2026/0358174 A1
(43) Pub. Date: Nov. 12, 2026

(54) Method and apparatus for inspecting painted surfaces with effect pigments

(71) Applicant: BYK-Gardner GmbH, Geretsried (DE)

(72) Inventor: Uwe SPERLING, Geretsried (DE)

(21) Appl. No.: 19/135,361

(22) PCT Filed: Nov. 21, 2023
(86) PCT No.: PCT/EP2023/082519

§ 371 Date: Jun. 3, 2025

(30) Foreign Application Priority Data
Dec. 9, 2022 (DE) 10 2022 132 807.4

(51) Int. Cl. G01J 3/46; G01J 3/02; G01J 3/50

(52) U.S. Cl. CPC G01J 3/465; G01J 3/027; G01J 3/504

(57) ABSTRACT

A method and apparatus for inspecting lacquered surfaces which preferably have one or more layers with absorption pigments and/or effect pigments, wherein an image evaluation device carries out a section-by-section and preferably pixel-by-pixel evaluation of an image recorded by an image recording device, wherein a colour image recording device also is used for evaluating and/or assessing the absorption and/or effect pigments, and/or the influence of effect pigments on the image recording and/or an integral colour measurement being taken into account and/or eliminated as part of the image evaluation.

The present invention relates to a method and an apparatus for inspecting lacquered surfaces, and in particular those surfaces which preferably have a lacquer mixture comprising absorption pigments and effect pigments. Such lacquer layers have been known from the prior art for a long time. Various methods and apparatuses for inspecting and/or analyzing such surfaces are also known from the prior art.

It is known that the spectral characteristic of an illuminated measuring spot is recorded with a dispersive element (such as a grating, prism or filter) and this is compared with a standard, for example. It is also known that the measurement results of such measurement methods often deviate greatly from each other, on the one hand because the differences between the image recording characteristics of a camera on the one hand and the human eye on the other are not sufficiently taken into account and on the other hand because optical filter devices also differ greatly.

A procedure is therefore sought in order to enable an evaluation of images of such surfaces that is as uniform or characteristic as possible. According to the invention, this is achieved by the subject matters of the independent patent claims. Advantageous embodiments and further developments are the subject of the subclaims.

In a method according to the invention for inspecting lacquered surfaces, which preferably have one or more layers with absorption and/or effect pigments, radiation is irradiated onto the surface to be inspected at a first predetermined angle of incidence by at least one first radiation device and a color image recording device records a spatially resolved image of the surface irradiated by the irradiation device at a different angle of observation. This image recording device has a first predetermined sensitivity dependent on a wavelength of the radiation impinging on the image recording device.

According to the invention, an image evaluation device performs a section-by-section and preferably pixel-by-pixel evaluation of the image recorded by the image recording device, wherein the color image recording device is also used to evaluate and/or assess the absorption and/or effect pigments and/or the influence of effect pigments and/or absorption pigments on the image recording and/or the integral color measurement is taken into account and/or eliminated as part of the image evaluation.

Effect pigments give the coating a color impression that is strongly angle-dependent (flop effect). In contrast to classic pigments (absorption pigments), effect pigments are often platelet-shaped in their geometry and their mode of operation is based on optical effects such as directional reflection or interference

The invention is therefore based on the idea that such effect or absorption pigments affect the recorded color image in different ways. The invention thus provides a new approach for separating colors from absorption pigments in such coatings.

It is now proposed to use color image (RGB) cameras and to evaluate their data quantitatively, in particular by observing only the images themselves.

As mentioned, a first approach is to adapt the RGB channel sensitivity curves to the tristimulus curves of the human eye using an equalizer filter.

In the context of the present invention, an additional approach is proposed to distinguish the high-precision color measurement of the absorption pigments from the measurements of the effect pigments.

In a preferred method, a classification of absorption and/or effect pigments is made with regard to at least one property characteristic of these absorption and/or effect pigments. This means that a distinction is made with regard to certain properties as to whether absorption or effect pigments are observed.

In a further preferred method, a cluster formation is carried out. This can be carried out according to different criteria. Particularly preferred is a cluster formation according to a predetermined characteristic property. Preferably, this characteristic property is selected from a group of properties which contains a pigment size, certain a* and/or b*. For example, the pigments found in an image can be divided into different groups of pigment sizes, for example in such a way that a first number n1 of the effect pigments is found which have a first specific pixel size and a second number n2 of effect pigments which have a second pixel size. The a* and b* values can also be classified accordingly.

In a preferred method, a distinction is made between absorption pigments and effect pigments during image evaluation. For example, it is advantageous that the above-mentioned value L*a*b* is only determined for absorption pigments.

In a further preferred method, different coatings are classified. Preferably, a spectrum is measured here at a high angle to the specular gloss reflectance (for example at an angle of) 110°. The reason for using this angle is that the effect pigments or flakes are expected to have the least influence on the overall measured spectrum.

Preferably, the coating is selected from a group of coatings which includes silver metallic coatings, chromatic metallic coatings, xyrallic or MICA coatings or interference coatings.

Silver metallic coatings only have aluminum pigments. These may contain a small amount of TiO2 or be slightly colored. A gray-neutral spectrum is to be expected.

Chromatic-metallic coatings have a low proportion of aluminum and only a few flakes are visible at 110°.

Xyrallic or MICA coatings have extremely low proportions of effect pigments (<1%) at 110°, only very few pigments or flakes are visible.

In a further preferred method, the influences of at least some of the absorption and/or effect pigments are eliminated, in particular as part of the image evaluation. This means that for the evaluation of an image, in particular reflections of absorption or effect pigments are eliminated, in particular if these reach an intensity above (or below) a certain threshold. It is therefore particularly preferable to create a threshold value that eliminates reflections or shadows from effect pigments, for example. This is explained below with reference to the figures.

In a further preferred method, interfering features on the surface are identified and surface areas with such interfering features are preferably excluded from the evaluation. For example, areas of a surface with scratches or fingerprints can be excluded from the evaluation. This is based on the fact that in these cases the visual impressions are also significantly influenced by these interfering effects such as scratches or fingerprints, and these are influences that are not due to the surface itself, but rather to the interfering effects.

It is proposed that an image evaluation recognizes such features as fingerprints or scratches and causes these areas to be excluded from the overall evaluation of an image. In this way, a more accurate measurement can be achieved.

Advantageously, an image evaluation device carries out a section-by-section and preferably pixel-by-pixel evaluation of the image recorded by the image recording device.

Preferably, the surface is the exterior surface of a motor vehicle and in particular a lacquered exterior surface of a motor vehicle and in particular a passenger car. However, other surfaces could also be examined, such as the surfaces of pieces of furniture.

Preferably, the results of this evaluation are used and/or taken into account for (future) measurements by the apparatus used in the evaluation. Preferably, a “filter device” and in particular a software filter device is determined and/or generated by the evaluation, which is taken into account and/or used for (future) measurements.

For example, as mentioned above, the evaluation can be carried out pixel by pixel in relation to the image recording device. This evaluation allows at least one calibration value to be assigned to each pixel or each area of pixels for future measurements. This calibration value is preferably determined as part of the evaluation for each individual pixel. For future measurements with the apparatus, the calibration value determined as part of the evaluation (in particular for each pixel) can also be taken into account when outputting measurement results for each individual pixel of the image recording device.

Methods are known from the applicant's internal prior art in which an optical filter device is arranged between the surface and the image recording device. This is also intended to compensate for different evaluation characteristics of the human eye on the one hand and a camera on the other. However, it has been shown that such filter devices themselves exhibit a high degree of scattering (in terms of their properties) and therefore lead to different evaluations. In addition, corresponding lighting devices such as LEDs are also subject to strong scattering. This means that even two LEDs from the same manufacturer, which should be identical in themselves, differ from each other in terms of their beam characteristics. Furthermore, there is also a high diversity of RGB filters from camera to camera and even within a single camera.

For this reason, there is a need for a specially adapted filter that takes into account changes in the camera or light source characteristics (for example, if the camera chip or LED needs to be replaced). In addition, only one standard illuminant is possible in the state of the art. By introducing a specially adapted filter, different standard illuminants can be taken into account mathematically.

The invention thus proposes a section-by-section and in particular pixel-by-pixel evaluation of the image, in particular also as a function of the wavelength, in order to be able to adapt to the respective conditions, i.e. to a specific radiation characteristic of the illumination device and also to an image recording device or its characteristic. It is possible for said evaluation to be repeated, for example at predetermined times. The result and/or the measured value(s) of the evaluation are preferably stored.

As is known per se from the state of the art, the image recording device has an image recording element with a plurality of image pixels, each of which is suitable for detecting the radiation impinging on it. For example, the image recording device could have a CCD chip. The evaluation is carried out for at least some of the pixels mentioned, preferably for at least 30%, preferably at least 50%, preferably for at least 60% and particularly preferably for at least 70% of the pixels mentioned. The evaluation can be carried out for each individual pixel, but it would also be conceivable for several pixels to be combined for an evaluation, thereby reducing the resolution of the evaluation to a certain extent.

For example, this type of image analysis could be carried out at predefined time intervals.

In a preferred method, the measurement signals of individual pixels are weighted taking into account the pixel-by-pixel evaluation. In this way, a software-based filter device can be used or generated, which in particular also influences the image evaluation for subsequent images.

In a preferred method, the evaluation is performed as a function of the wavelength of the radiation impinging the image recording device. This means that a wavelength-dependent evaluation of the sensitivity of the image recording device and, in particular, the sensitivity of each individual pixel is recorded as a function of the wavelength.

It is therefore particularly preferable for said evaluation to take place as a function of a wavelength-dependent (and in particular also pixel-by-pixel) sensitivity of the image recording device. Preferably, an individual evaluation is carried out for each individual image recording device. Preferably, this evaluation is also carried out pixel by pixel.

Preferably, a wavelength-dependent sensitivity of the image recording device is determined. In particular, a pixel-by-pixel (in particular wavelength-dependent) sensitivity can be determined or the wavelength-dependent sensitivity can be determined for each individual pixel.

However, it would also be possible for the evaluation to be carried out across several pixels, for example by averaging several pixels of the same intensity.

In a further preferred method, the image recording device and in particular a color image camera is also used to evaluate and/or assess the effect pigments.

In a further preferred method, the influence of effect pigments on the image recording and/or the integral color measurement is taken into account and/or eliminated, in particular during image evaluation.

In the state of the art, there is the problem that integral color measurements can be subject to errors, since it is not possible to differentiate whether the measurement results that occur are due to the color of a flake or effect pigment or have another cause. The preferred proposed method allows such a distinction to be made. More precisely, a spatially resolved color measurement is used for this purpose.

With integral color measurement, errors can occur in particular if the effect pigments themselves produce colored effects, in particular in a different color than the color caused by the absorption effects

For example, a solid color with only one absorption pigment (e.g. solid red) and the same absorption pigment (e.g. red) with the addition of colored effect pigments would result in different color values XYZ being measured in the integral color measurement.

Multi-angle colorimeters known from the state of the art enabled an integral, averaged, non-location-resolved color measurement over the entire illuminated measuring spot at several angles. In the history of device developments, the first devices were without a camera, later camera devices were added. The camera measurement was used exclusively to evaluate the ‘glitter’ directed light (direct sunlight) and the ‘graininess’ (diffuse lighting, overcast sky) and is an additional information independent of the colour measurement for the characterization of effect pigment lacquers.

The use of cameras in multi-angle colorimeters when measuring solid color lacquers (which only contain absorption pigments) is unnecessary and only makes sense for effect lacquers that contain a mixture of absorption pigments and one (or more) types of effect pigments.

The method proposed here eliminates the influence of the effect pigment measurement on the absorption pigment measurement and would result in both measurements obtaining the same values in the above example.

In a preferred method, the influence of the effect pigment measurement on the measurement of the absorption pigment(s) is reduced and/or eliminated.

In a preferred embodiment, it is proposed in the context of the invention that the image recording device and in particular a color image camera is also used to evaluate and/or assess the effect pigments (and in particular their color properties)

Furthermore, however, information is preferably obtained about the colorfulness and/or color distribution of the areas of the image which are attributable to and/or contain effect pigments. This means that the advantages achieved by using a color image camera can still be retained.

Preferably, the wavelength-dependent sensitivity is determined by a spectrometer and/or a monochromator and/or the evaluation of the image recorded by the image recording device is carried out by a spectrometer and/or a monochromator. Several procedures are conceivable for determining the spectral sensitivity of an image recording device and in particular of each individual pixel.

For example, it would be possible to use the following equations to obtain the characteristic curves of the individual channels of an RGB-CMOS/CCD camera chip, which preferably has a Bayer pattern, as sums over a plurality of wavelengths.

$$p = s ( {λ}_{1} ) E ( {λ}_{1} ) + ⋯ + s ( {λ}_{n} ) E ( {λ}_{n} )$$

$$\begin{matrix}{p}_{j} = {s}_{i} {E}_{i , j} & \vert\end{matrix} i , j = 1 … n$$

$${p}_{j} {E}_{i , j}^{- 1} = {s}_{i}$$

$${p}_{j , k} {E}_{i , j}^{- 1} = {s}_{i , k} \qquad │ k = 1 … \qquad number of the pixel$$

Where p denotes the measured value (red, green, blue). s(lᵢ)=sᵢ denotes the spectral sensitivity of the pixel/filter combination. E_{i,j} denotes the calibration tile with known reflectance spectrum number j at the wavelength lᵢ.

In addition, it would also be possible to carry out a multiple linear regression. This can be carried out using the following equations:

$${p}_{j} = s ( {λ}_{1} ) {E}_{j} ( {λ}_{1} ) + ⋯ + s ( {λ}_{n} ) {E}_{j} ( {λ}_{n} ) \qquad i = 1 …n , j = 1 …m \vert m > n$$

$${s}_{i , k} = ( \begin{matrix}{s}_{1 , k} \\ ⋮ \\ {s}_{n , k}\end{matrix} ) = {( {E}^{T} E )}^{- 1} {E}^{T} ( \begin{matrix}{p}_{1 , k} \\ ⋮ \\ {p}_{m , k}\end{matrix} ) \qquad k = 1 … \qquad number of the pixel$$

In the context of the present invention, it is proposed to determine the spectral sensitivity for each pixel by a monochromator and/or a (in particular absolutely calibrated) spectrometer. On the basis of these recorded spectral sensitivities, deviations can be determined in each case and these deviations can be taken into account in the subsequent image evaluation in order to record and/or output a colorimetrically correct image of the individual pixels.

In a preferred method, in order to determine the wavelength-dependent sensitivity of the image recording device, radiation is irradiated onto the surface at a predetermined angle onto a set of reference surfaces with known reflectance and the image recording device records an image of this surface. Preferably, this angle is greater than 20° with respect to a perpendicular direction, preferably greater than 30°, preferably greater than 40°, preferably greater than 50° and particularly preferably greater than 60°.

Additionally or alternatively, it would be possible for the surface to be illuminated with a monochromatic light from a further, in particular external, auxiliary light source. These auxiliary light sources can be, for example, monochrome LEDs or white light filtered using a plurality of bandpass filters. Here too, the illumination angle is preferably greater than 20° with respect to a perpendicular direction, preferably greater than 30°, preferably greater than 40°, preferably greater than 50° and particularly preferably greater than 60°.

The reason for recording the images with illumination at a very large angle or very flat illumination with respect to the direction of extension of the surface to be observed is that these surfaces behave in the least distorted manner defined by the effect pigments used in the coating under these illuminations. Silver metallic coatings, for example, consist only of aluminum flakes or partly of flakes with a certain proportion of TiO2.

In this case, a gray neutral light direction spectrum can be expected under a flat angle of incidence or illumination. Further surfaces have chromatic metallic coatings with aluminum and usually have only a small number of effect pigments. In this case, only a few of these flakes are visible at flat lighting angles. So-called xyrallic or MICA coatings have even fewer effect pigments, i.e. in this case none of these flakes are visible at the angles mentioned. Preferably, the image evaluation is carried out separately and/or independently for the absorption pigments and for the effect pigments (flakes).

Preferably, in the case of the formulation of the absorption pigments, a pixel number is recorded and/or stored together with the intensity value assigned to it or determined (output by the relevant pixel). In a further step, a histogram can be recorded and a maximum value of the respective frequency can be determined. In a further step, an average value XYZ is preferably recorded for a statistically defined number of pixels.

For the evaluation of the effect pigments, flakes are preferably selected which are separate from each other and which reach or cover all three filters (i.e. whose emission characteristics or emission maxima lie in the respective wavelength ranges of the relevant filter devices of the image recording device) and the product XYZ is only determined for these flakes. Preferably, no demosaicing is used in this case. Preferably, at least two images are recorded with a specific exposure time.

Preferably, the color effect of the absorption pigment is assessed with an image taken at a first predetermined angle, in particular an angle away from the gloss, in which the distortion of the color measurement by the effect pigment can be neglected to a good approximation.

An angle away from the gloss is understood to be an angle that deviates from the direction of reflection by at least 30°.

The sparkles caused by the effect pigments are preferably identified with a camera image taken at a second, in particular near-gloss, angle. A near-gloss angle is understood to be an angle that deviates from the direction of reflection by no more than 25°, preferably no more than 20°, preferably no more than 15°.

Due to the near-gloss angle, the effect pigments can be identified in the camera image as areas of high intensity (above a certain threshold), i.e. it is known with pixel accuracy whether it is an area on the sample with absorption pigment or effect pigment.

In a further advantageous method, a sensitivity of the human eye dependent on a wavelength of the radiation striking the human eye is taken into account during evaluation and/or measurement with the apparatus.

In a further preferred method, data determined as part of the evaluation is taken into account in order to generate a filter device, in particular a software filter device, for subsequent measurements with the apparatus that also performs the evaluation, which calibrates the measured values recorded or determined by the image recording device. Preferably, the recorded image is calibrated pixel by pixel and/or the measured values output by the individual pixels are calibrated individually.

It is possible that differences between this first sensitivity (of the image recording device) and a second sensitivity (of the human eye) are at least partially compensated for by one and in particular the said filter device.

In a further preferred method, radiation is irradiated onto the surface by a second radiation device and a second predetermined angle of incidence and the image recording device records an image of the surface irradiated by the second radiation device. Alternatively, a second observation device can also be used. In addition, a third radiation device is also preferably provided, which irradiates radiation onto the surface to be examined.

Illumination is particularly preferred at different angles. In a further preferred method, at least one radiation device emits directed or diffuse radiation onto the surface.

In a further preferred method, the data recorded during the evaluation is reduced, wherein this data reduction preferably differs with regard to the absorption pigments and the effect pigments. Data reduction can be performed, for example, in such a way that when evaluating the wavelength-dependent sensitivity of a pixel or when evaluating the impinging radiation, only those wavelength ranges are examined in which a certain intensity (which results in particular from the course of the spectrum), for example a (local) intensity maximum, occurs. In this way, an intensity limit can be determined which enables the detection of areas without flakes. In this way, those areas of an image that contain images of flakes or those areas that are free of flakes are preferably identified.

When observing surfaces, the problem arises that commercially available image recording devices such as RGB cameras have a certain wavelength-dependent sensitivity, which differs from the wavelength-dependent sensitivity of the human eye. Accordingly, the object is to enable the most realistic possible image recording of the irradiated surface (or the most realistic possible evaluation of this image recording).

The invention therefore proposes to achieve at least partial adaptation of the image recording device to the human eye by a filter device (which is in particular a software filter device and in particular such a filter device which takes into account the data recorded during the evaluation).

The CIE standard valence system or CIE standard color system is a color system defined by the International Commission on Illumination (CIE-Commission internationale de l′éclairage) in order to establish a relationship between human color perception (color) and the physical causes of the color stimulus (color valence). It captures the totality of perceptible colors. Using the color space coordinates, the term Yxy color space or CIE-Yxy is also commonly used, as well as tristimulus color space, primarily in the English-speaking world.

Especially in the English-speaking world, the three basic values X, Y and Z are referred to as tristimulus. In this meaning, they are the three parts of the standardized basic colors defined (for this purpose). Each color can be identified with such a number triplet. Accordingly, the term tristimulus system is commonly used for the CIE standard system. The curves are also called tristimulus curves.

In one embodiment, an image is therefore recorded and the individual pixels are evaluated, in particular with regard to colors, wherein a wavelength-dependent evaluation and/or weighting is carried out.

In a preferred method, the evaluation is carried out in such a way that the wavelength-dependent differences between the first sensitivity (of the image recording device) and the second sensitivity (of the human eye) are at least temporarily compensated for.

When selecting the filter device, an emission spectrum L(λ) of the radiation device, an intensity curve I(λ) of a standard light, at least one tristimulus function X(λ), in particular of the human eye, and/or a value and/or curve characteristic of a filter characteristic F(λ) of the image recording device are particularly preferably taken into account.

Preferably, the wavelength-dependent transmission T(λ) results from a filter device to:

T(λ)=X(λ)/(I(λ)·L(λ)·F(λ))

I(λ) indicates the wavelength-dependent characteristic of the illuminant, for example D65, L(λ) the wavelength-dependent characteristic of the light source, F(λ) the wavelength-dependent characteristic of the observation device (in particular an RGB filter and in particular its filter) and X(λ) the wavelength-dependent light receptivity of the eye (tristimulus functions).

Preferably, the wavelength-dependent characteristic of the observation device and the wavelength-dependent light sensitivity of the eye have different functions over at least two, preferably three, predetermined wavelength ranges.

Preferably, the first wavelength range extends from 300 nm-600 nm, preferably from 350 nm-550 nm and preferably from 400 nm-500 nm. Furthermore, the second wavelength range is preferably from 400 nm-700 nm, preferably 450 nm-650 nm, and preferably 500 nm-600 nm. Furthermore, the third wavelength range is preferably from 400 nm-800 nm, preferably from 500 nm-700 nm and preferably from 550 nm-650 nm.

The entire range of perception of the human eye is preferably covered.

The wavelength-dependent characteristics of the observation device can also be divided into the above-mentioned wavelength ranges.

In a further preferred method, radiation is irradiated onto the surface at a second predetermined angle of incidence by a second radiation device and the image recording device records an image of the surface irradiated by the second radiation device.

Preferably, the first and second radiation devices irradiate the surface at different times or periods of time. Alternatively or additionally, it would also be conceivable for a second image recording device to observe the surface at a second observation angle.

By irradiating using two or more irradiation devices, it is also possible to detect effects that result from differently aligned effect pigments.

In a further preferred method, a third radiation device is also provided, which preferably emits radiation onto the surface at a third angle of incidence.

In a further preferred method, the observation angle in relation to a direction perpendicular to the surface is less than 10°, preferably less than 5°, preferably less than 3°.

In a further preferred method, the first angle of incidence in relation to a direction perpendicular to the surface is between 70° and 20°, preferably between 60° and 30°, preferably between 50° and 40°.

Preferably, a second angle of incidence of the second radiation device relative to a direction perpendicular to the surface is between 85° and 50°, preferably between 85° and 60°, preferably between 85° and 70°.

Preferably, at least one radiation device directs directed or diffuse radiation onto the surface. By using diffuse radiation, solar radiation can be simulated when the sky is cloudy, and by using directed radiation, solar radiation can be simulated when the sky is cloudless.

Preferably, at least one further radiation device and preferably all radiation devices direct diffuse or, in particular, directed radiation onto the surface.

The present invention is further directed to an apparatus for inspecting lacquered surfaces which have a mixture of absorption pigments and at least one further effect pigment, having a first radiation device which irradiates radiation onto a surface to be inspected at a first predetermined angle of incidence and a color image recording device which records a spatially resolved image of the surface irradiated by the direction of incidence at a first angle of observation, wherein this image recording device having a first predetermined sensitivity which is dependent on a wavelength of the radiation incident on the image recording device.

According to the invention, the apparatus has an image evaluation device which carries out a section-by-section and preferably pixel-by-pixel evaluation of the image recorded by the image recording device.

Furthermore, the color image recording device can also be used to evaluate and/or assess the absorption and/or effect pigments, and/or the image evaluation is suitable and intended to take into account and/or eliminate the influence of effect pigments on the image recording and/or the integral color measurement.

In a preferred embodiment, the apparatus has a memory device in which the measured values determined by the evaluation device are stored. Preferably, the memory device allows these measured values to be stored pixel by pixel.

In a further preferred embodiment, the apparatus has a filter device and in particular a software filter device which calibrates further images recorded by the image recording device and in particular calibrates them taking into account the values determined by the evaluation device and/or which is suitable and intended for this purpose.

Preferably, the filter device (and/or a processor device implementing this filter device) is suitable and intended for calibrating recorded images pixel by pixel.

Preferably, this filter device is changeable, i.e. in particular the way in which this filter device affects the images output by the image recording device is changeable. This means that by modifying the (software) filter device, the images output by the image recording device and/or measured values output by the apparatus in general can also be changed.

Preferably, the apparatus can be operated in a calibration mode in which the images recorded by the image recording device are evaluated and the software filter device is determined and/or modified. Preferably, the apparatus can also be operated in a working mode in which, in particular, a software filter device determined in the calibration mode is used.

Preferably, the apparatus has a calibration device which is suitable and intended for calibrating each individual pixel.

Particularly preferably, this is a calibration in an XYZ color space of the RGB camera.

Preferably, the apparatus is a multi-angle measuring device, which is therefore suitable and intended for inspecting the surface at several (illumination and/or irradiation) angles.

However, the invention can also be used for uni-lacquers (without effect pigments) for motor vehicles (or other surfaces).

Preferably, the radiation device and the observation device and possibly also the filter device are arranged in a common housing. Preferably, an inner wall of this housing is designed to be light-absorbing. In a further preferred embodiment, the housing has essentially only one opening through which the surface is observed. In a further preferred embodiment, the device is portable

In a further preferred embodiment, the image recording device has filters and in particular RGB filters. Preferably, the radiation device emits standardized light and in particular D65 standardized light. Standardized light refers to the standardized spectral radiation distribution curves of characteristic emitters. The standardized light type D65 is a radiation distribution with a color temperature of 6504 Kelvin (which corresponds approximately to a gray overcast sky).

In a preferred embodiment, the distance between the surface and the radiation device is between 3 cm and 30 cm, preferably between 4 cm and 20 cm and preferably between 4 cm and 10 cm.

In a preferred embodiment, the radiation device is suitable and intended to emit radiation of different wavelengths. A filter device such as a filter wheel with different filters can be provided, which only allow light of certain wavelengths to pass through.

In a further preferred embodiment, the first radiation device has a light-emitting diode (LED) and in particular a tri-phosphor LED. Preferably, as mentioned above, the apparatus also has further radiation devices. These preferably also have light-emitting diodes and in particular tri-phosphor LEDs.

In a further preferred embodiment, the apparatus has at least one second radiation device and/or a second sensor device. This second sensor device can also be designed as an image recording device, but it is also conceivable that this sensor device is a sensor device which determines the intensity of the radiation impinging on it.

In a further preferred embodiment, the apparatus has at least three radiation devices (or illumination devices), which preferably illuminate the surface from at least three different angles.

In a further preferred embodiment, the filter device performs a pixel-by-pixel calibration of the values or signals output by the individual pixels of the image recording device.

Further advantages and embodiments are shown in the attached drawings: In the drawings:

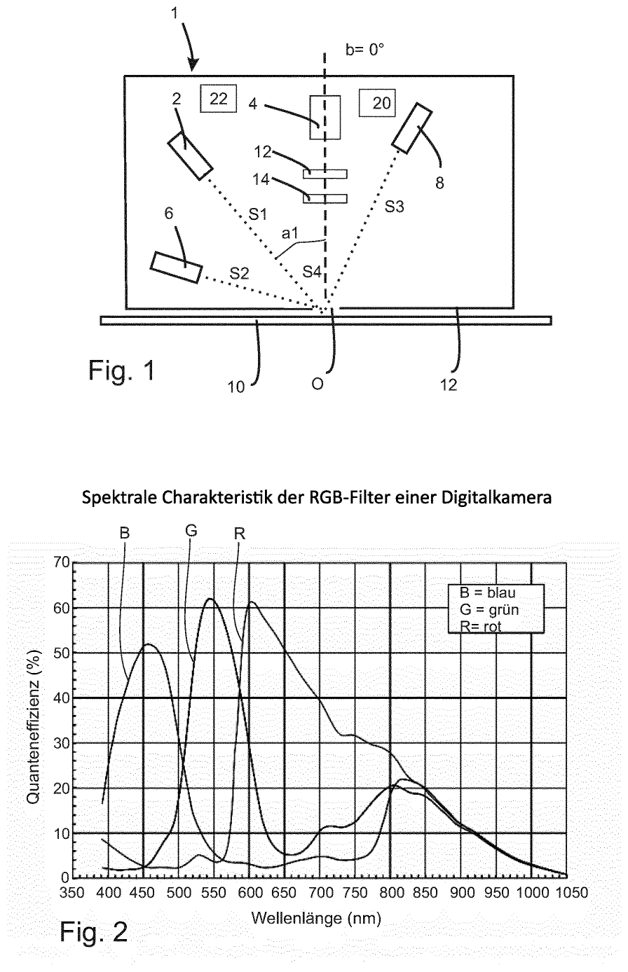

FIG. 1 shows a schematic representation of an apparatus according to the invention;

FIG. 2 shows a representation of a spectral characteristic of the RGB filters of a digital camera;

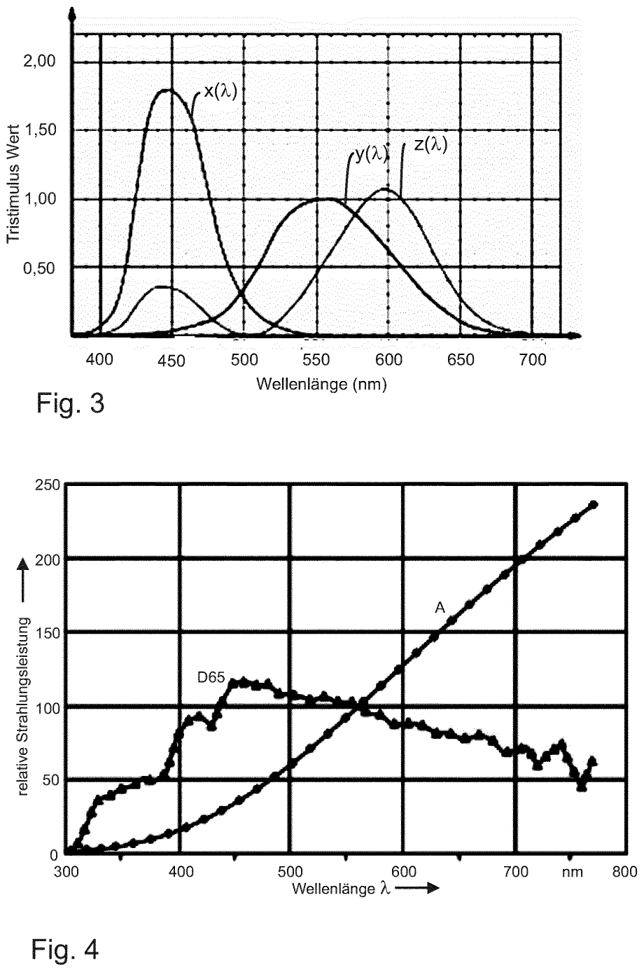

FIG. 3 show sensitivity curves of the 3 color receptors X (red), Y (green) and Z (blue);

FIG. 4 shows a representation of the radiant power of standardized light D65;

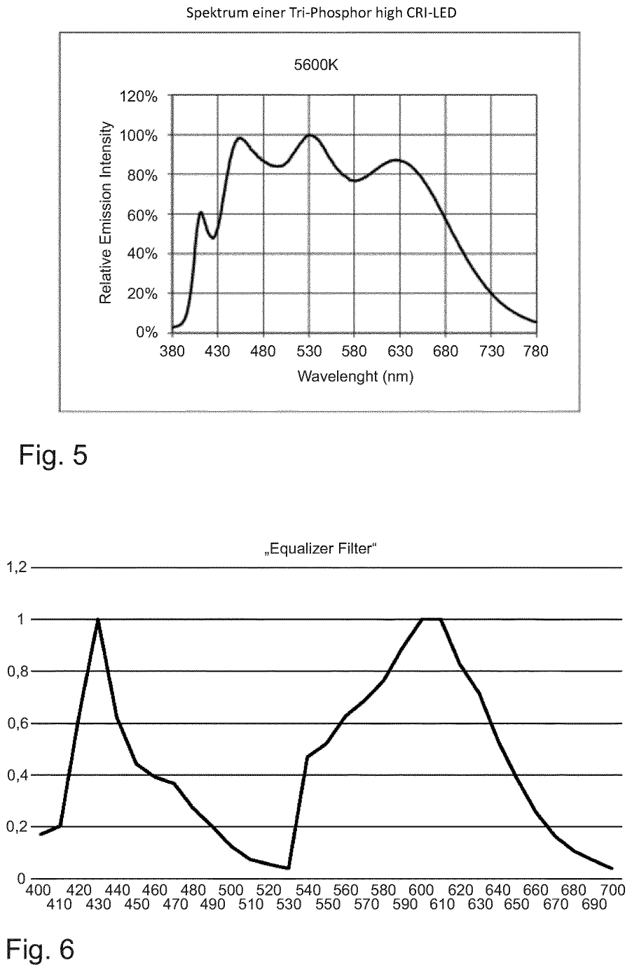

FIG. 5 shows an emission spectrum of an LED;

FIG. 6 shows a transmission behavior of a filter device;

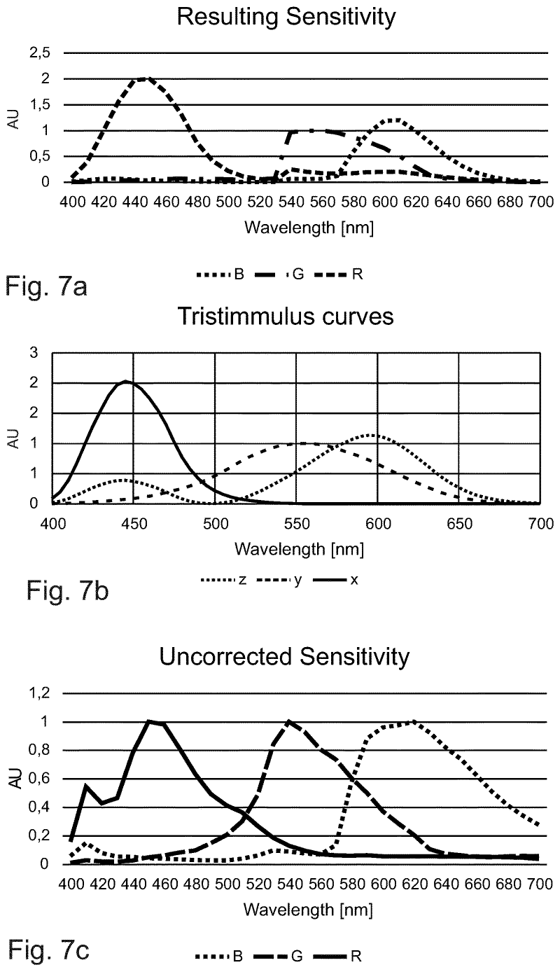

FIG. 7a-c show comparison of the resulting sensitivities;

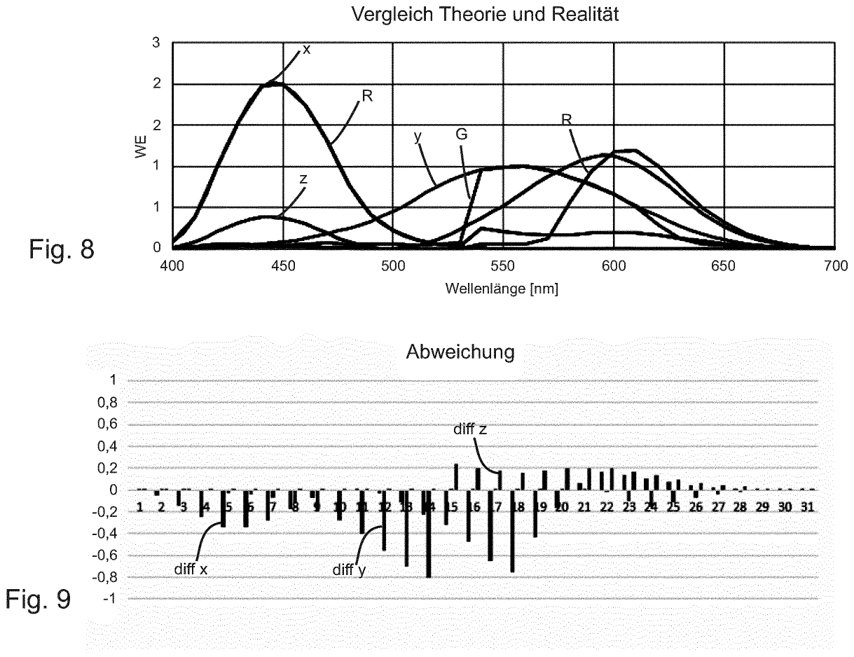

FIG. 8 shows a comparison of theoretical and actual intensity curves;

FIG. 9 shows a representation of deviations between a theoretical and an actual course

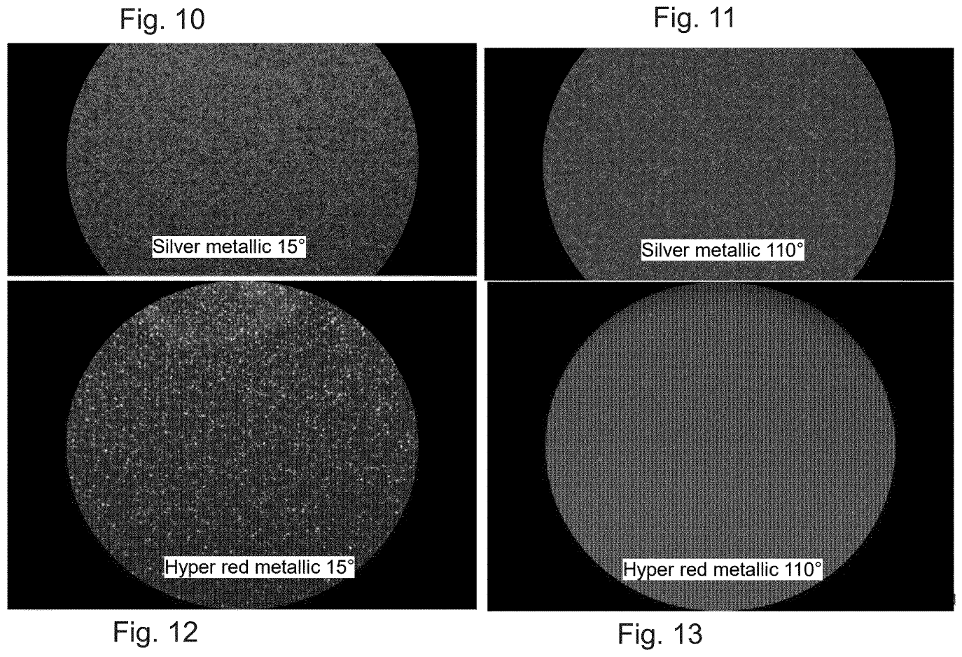

FIG. 10 shows an image of a silver metallic coating at 15°;

FIG. 11 shows an image of a silver-metallic coating at 80°;

FIG. 12 shows an image of a hyper red metallic coating at 15°;

FIG. 13 shows an image of a hyper red metallic coating at 80°;

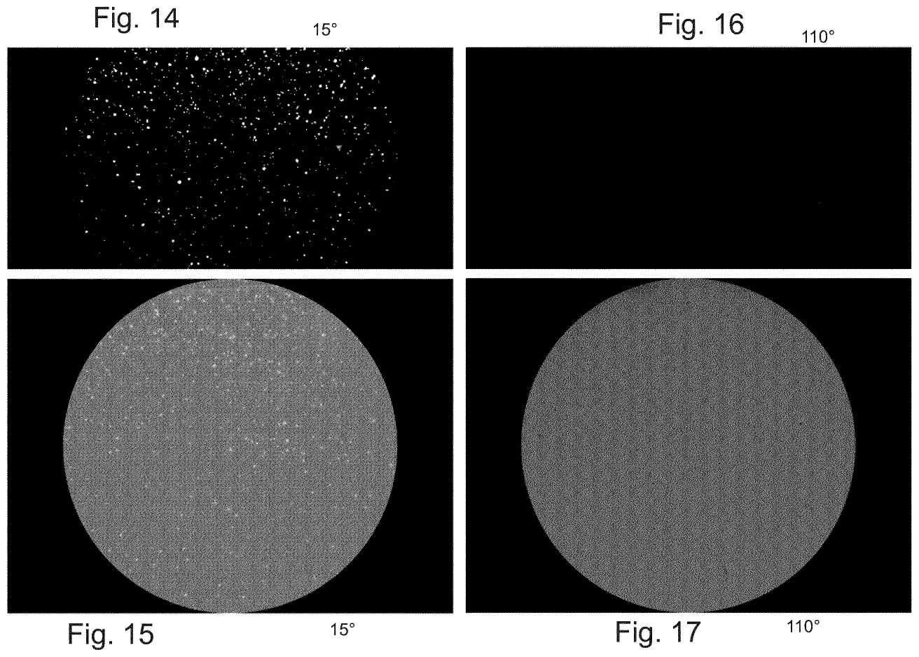

FIG. 14 shows a RGB camera image of a Christal silver xyrallic coating with black as the base color at an observation angle of 15°;

FIG. 15 shows a RGB camera image of a Christal silver xyrallic coating with white as the base color at an observation angle of 15°;

FIG. 16 shows a RGB camera image of a Christal silver xyrallic coating with black as the base color at an observation angle of 80°;

FIG. 17 shows a RGB camera image of a Christal silver xyrallic coating with white as the base color at an observation angle of 80°;

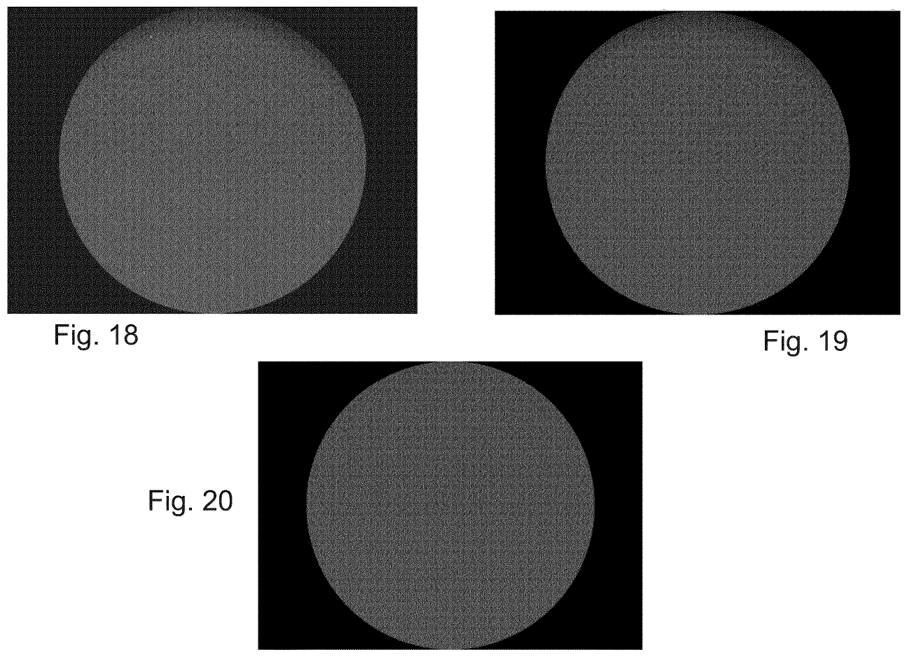

FIG. 18 shows a more detailed image of a hyper red metallic coating at 80°, with effect pigments visible as bright reflections (oriented) or dark dots;

FIG. 19 shows a more detailed image of a hyper red metallic coating at 80° in which the effect pigment areas oriented in the direction of reflection of the camera were removed using digital image processing;

FIG. 20 shows a more detailed image of a hyper red metallic coating at 80° in which, addition to FIG. 19, the misoriented effect pigment areas (visible as dark dots) have also been removed using digital image processing;

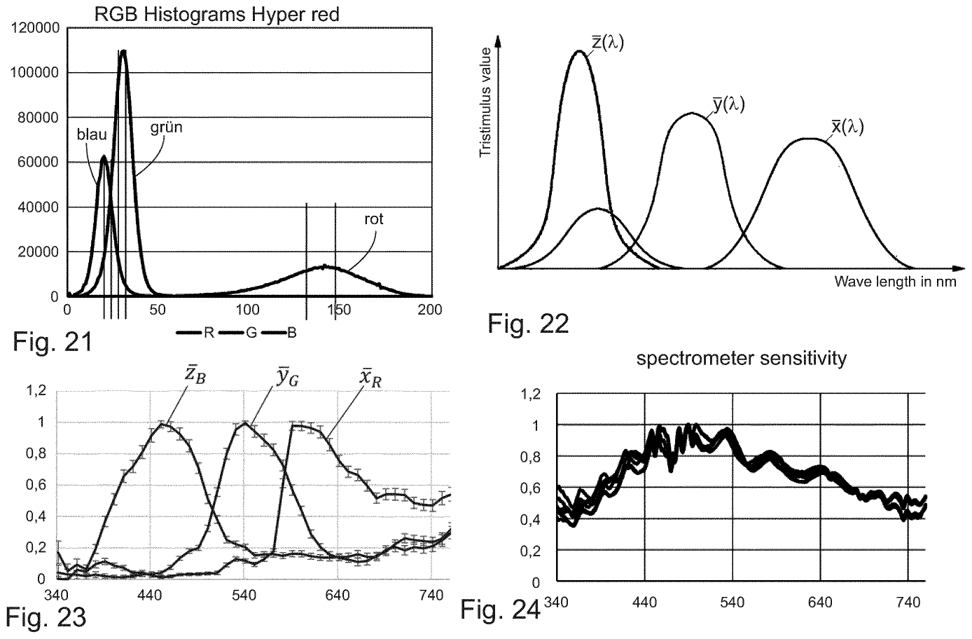

FIGS. 21-24 show four illustrations for calibrating the individual pixels;

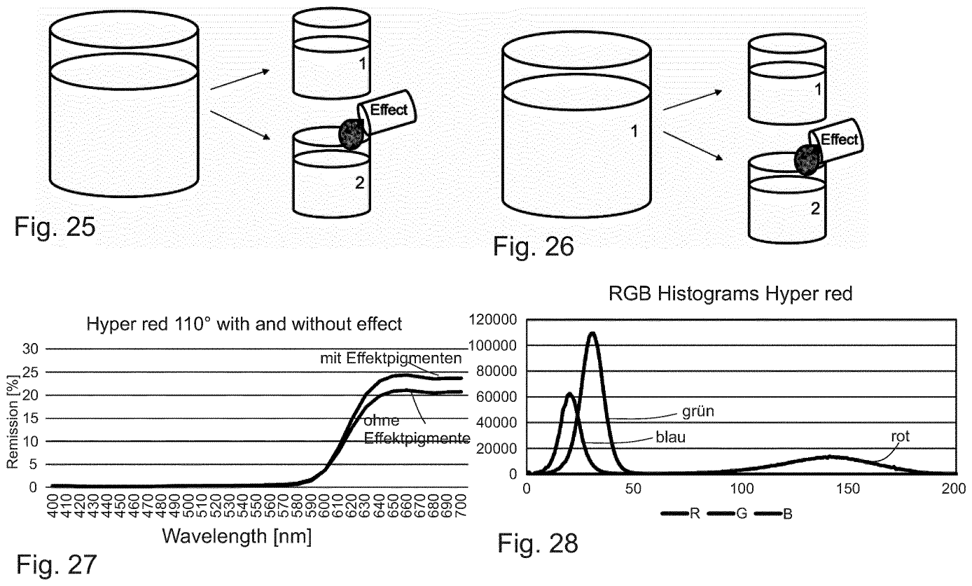

FIG. 25 shows a representation of a test procedure for Hyperrot;

FIG. 26 shows an illustration of a test method for mamba green;

FIG. 27 shows a comparison between a hyper red surface without effect pigments and a surface with effect pigments;

FIG. 28 shows a RGB histogram for hyperred;

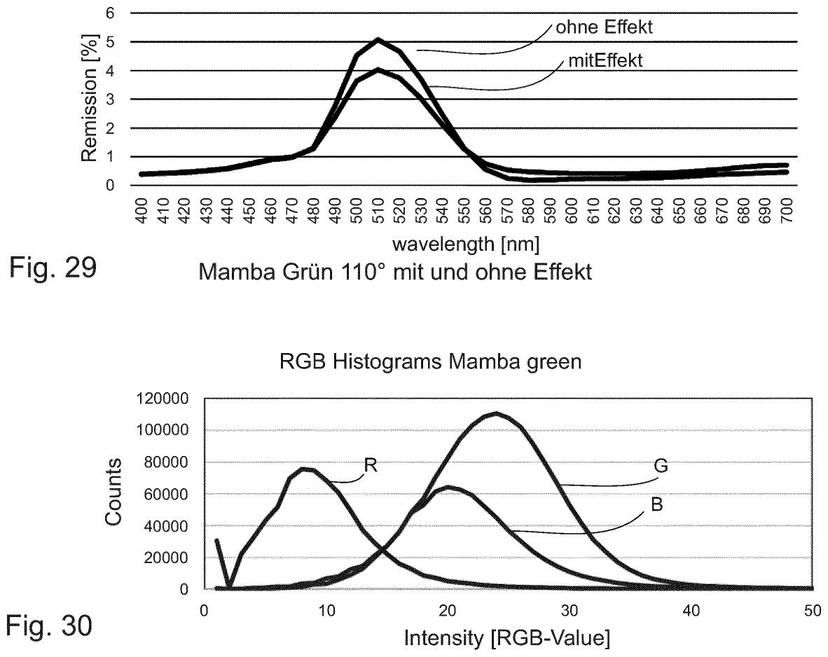

FIG. 29 shows a comparison between a mamba green surface without effect pigments and a surface with effect pigments;

FIG. 30 shows a RGB histogram for mamba green;

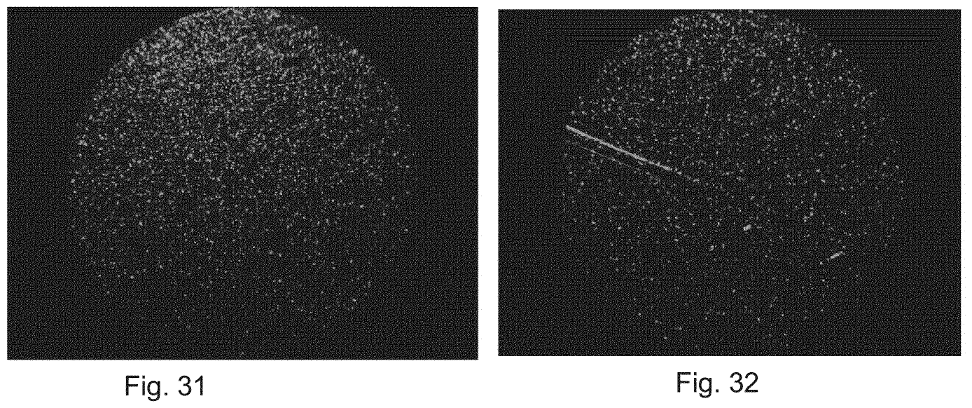

FIG. 31 shows an image of a hyper-red surface with a fingerprint;

FIG. 32 shows a picture of a surface with a scratch;

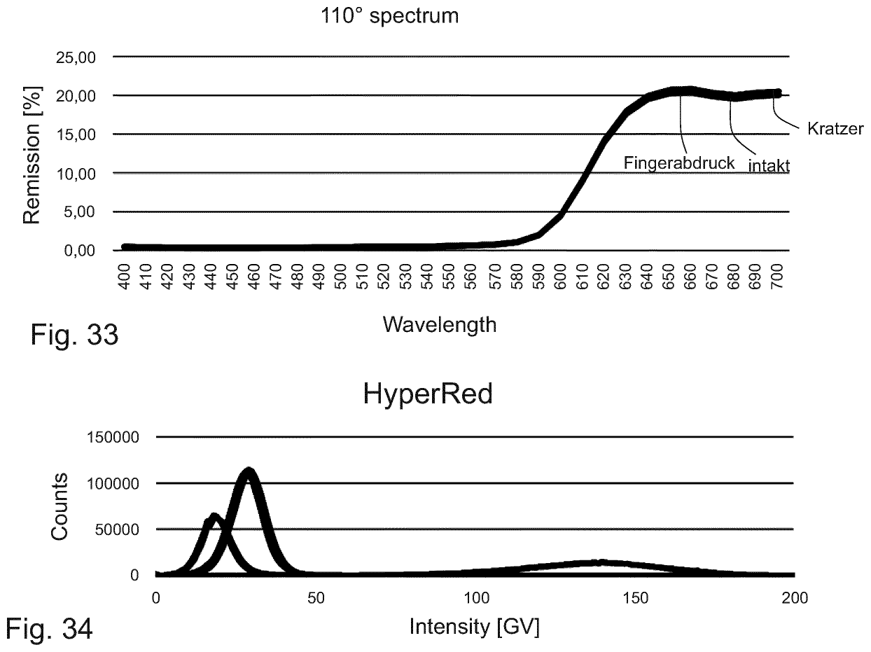

FIG. 33 shows a comparison between a surface without scratches and a surface with scratches;

FIG. 34 shows a representation of a camera-based measurement of the background color;

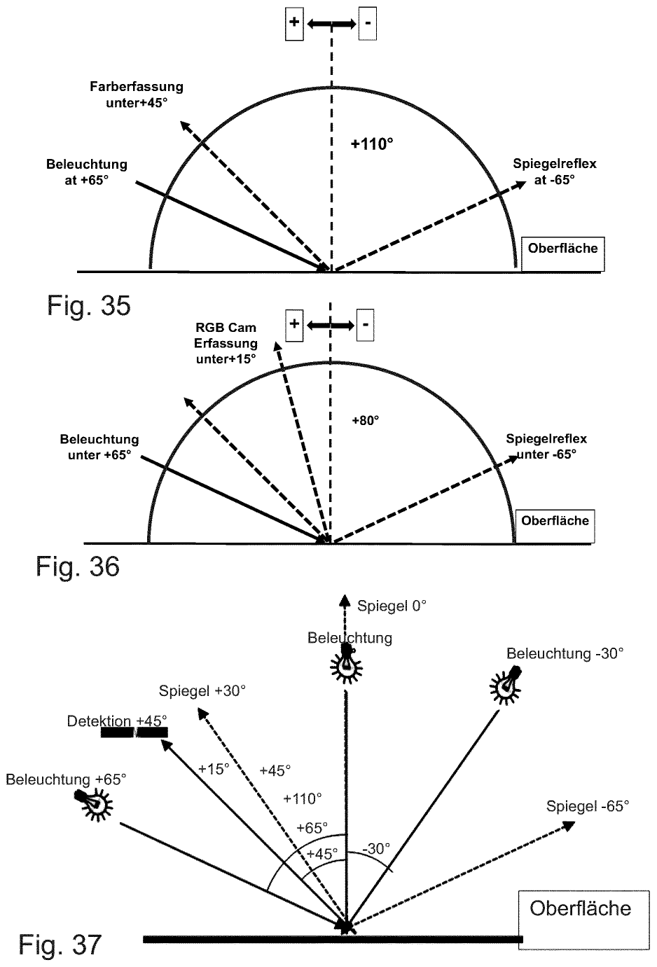

FIG. 35 shows an illustration of a measuring arrangement;

FIG. 36 shows a representation of a measuring arrangement; and

FIG. 37 shows a further illustration of a measuring arrangement.

FIG. 1 shows a schematic representation of an apparatus 1 for inspecting surfaces 10. This apparatus has a first radiation device 2 or illumination device 2, which irradiates light onto the surface 10 beam S2.

The reference sign 4 indicates an image recording device which records at least one spatially resolved image of the surface illuminated by the first radiation device (beam path S4). The reference sign O indicates an opening in the housing 12 through which the surface 10 is irradiated and through which the image recording device 4 observes the surface. The image recording device records the images at an observation angle of 0°, i.e. it is arranged perpendicular above the surface 10.

The reference sign 12 indicates an optionally available filter device which is arranged in the beam path S4 between the surface 10 and the image recording device and through which the image recording device records an image of the surface 10.

The reference sign 14 indicates an optionally available lens device, which serves to collimate the light reflected and/or scattered by the surface 10 so that it also impinges the filter device in collimated form and preferably also perpendicular to the filter device.

The reference symbol 20 indicates an evaluation device that evaluates the images recorded by the image recording device 4. The evaluation device can preferably output data which are characteristic of physical properties of the surface.

The reference sign 22 identifies a processor device which calibrates and/or modifies the images recorded by the image recording device in a working mode of the apparatus and, in particular, calibrates and/or modifies them pixel by pixel and/or, in particular, calibrates and/or modifies them taking into account the data determined by the evaluation device. Preferably, therefore, this processor device determines the above-mentioned software filter device.

The reference symbol 6 indicates a second radiation device that also emits radiation and in particular light onto the surface (but at a different angle of incidence or along the beam path S2). This radiation device in particular can be used to evaluate the recorded images.

The reference sign 8 indicates a third radiation device, which also emits radiation and in particular light along a beam path S3 onto the surface 10.

Preferably, a control device (not shown) is provided which activates the radiation devices 2, 6 and 8 with a time delay.

FIG. 2 shows a characteristic of an image recording device as a function of the wavelength of the incident radiation. More precisely, the sensitivity of the RGB filters of this imaging recording device or camera is shown.

Three curves R, G, B are shown, which refer to the “red”, “green” and “blue” components. The quantum efficiency in % is plotted on the coordinate and the wavelength of the incident light is plotted on the ordinate.

It can be seen that the quantum efficiency of the camera as a whole first increases in the wavelength range between 400 nm and 800 nm and then decreases again. In this way, the image recording device has its own characteristics of image reproduction or image recording.

FIG. 3 shows a representation of the tristimulus functions of the human eye. Here, too, three curves x(λ), y(λ) and z(λ) are shown, wherein the wavelength in nm on the ordinate and the tristimulus value on the coordinate are recorded.

A comparison of the illustration shown in FIGS. 2 and 3 show that the wavelength-dependent sensitivity curve of the image recording device and the human eye differ considerably. These differences are to at least partially compensated for by the invention.

FIG. 4 shows an illustration of an intensity curve of a D65 standardized light source in a range between 300 nm and 800 nm. This type of light is approximated to the curve for daylight and cloudy skies. The second curve A shows the curve of a conventional incandescent lamp.

The standardized illuminant type D represents the daylight spectrum and is therefore of particular interest for many industrial areas. The D65 illuminant derives its name from the color temperature of 6,504 Kelvin (K). D65 is used in the chemical and pharmaceutical industries, in paint production and in the ceramics, fabric, paper and automotive industries.

The standardized illuminant type D65 has a high blue component, with which fluorescent colors can be recognized.

D65 is used as an evaluation light source. The spectral distribution of D65 light sources is defined in DIN 5033 and lies between wavelengths of 300 nm and 780 nm, i.e. between ultraviolet and red.

FIG. 5 shows an emission spectrum of a light source preferably used in the context of the invention, namely a tri-phosphor high CRI LED. It can be seen that this light source essentially emits between 400 and 800 nm. The color temperature here is 5600 K. This radiation characteristic is also preferably taken into account in the design of the filter device.

The abbreviation CRI stands for the color rendering index. The color rendering index is a quantitative measure for a light source and describes the ability to reproduce colors of objects in comparison to an ideal or natural light source. The term CRI is often used on commercially available lighting products. Correctly defined, it should be called Ra—general color rendering index—or Ri—specific color rendering index—according to the test color samples to be evaluated.

The CRI is calculated by comparing the color rendering of the test light source with that of a defined light source. For test light sources below 5000 K, a black-body spotlight is used as a defined comparison source. Daylight (D illuminant) is used for comparison for test light sources above 5000 K. The calculation of Ri and Ra is explained in detail in the CIE 13.3-1995 technical report. The test method uses a set of eight Ra or 14 Ri CIE-1974 color samples from an early edition of the Munsell color system. The first eight samples are moderately saturated, comprise the color tone circle and have approximately equal brightness. The remaining six samples provide additional information about the color rendering properties of the light source.

FIG. 6 shows a transmission curve of a filter device adapted for the present invention, as calculated from the data described above and the equation shown above. Based on this data, a filter device is preferably manufactured which shows approximately the transmission behavior shown in FIG. 6. In the manufacture of filter devices, there are several methods for achieving a desired transmission curve, which have been explained above. In addition, a software filter can also be created on the basis of these values or the aforementioned adjustments can be made on the software side. Such adjustments can also be made pixel by pixel.

FIGS. 7a-7c show three representations of progressions (plotted in arbitrary units on the coordinate). FIG. 7b again shows the progression of the human eye, which is also shown in FIG. 3. FIG. 7c shows the curve resulting from an image recording device without the filter device proposed according to the invention. FIG. 7a shows a sensitivity or a curve that results when the filter device is used. It can be seen that the curve shown in FIG. 7a is much closer to the “natural” curve shown in FIG. 7b than the curve shown in FIG. 7c.

FIG. 8 shows a diagram illustrating the method according to the invention. A comparison between the curves shown in FIGS. 7b and 7c is shown in more detail. It can be seen that these curves are close to each other in some wavelength ranges, but differ considerably in other wavelength ranges. The tristimulus curves X, Y, Z and, on the other hand, the resulting sensitivity curves B, G, R are shown.

FIG. 9 shows a diagram depicting the percentage deviations diff x, diff y, diff z of the curves from each other. It can also be seen here that there are large deviations in some areas and only small deviations in other areas.

As mentioned above, the measured spectrum is recorded at a very flat angle of incidence, as the influence of the individual flakes is very small in this case.

The values for X, Y and Z can be determined using the following equations:

$${X}_{n , m} = {kR}_{n , m} \frac{{\sum }_{i = 400}^{700} s ( {λ}_{i} ) I ( {λ}_{i} ) \overline{x} ( {λ}_{i} )}{{\sum }_{i = 400}^{700} s ( {λ}_{i} ) I ( {λ}_{i} ) \overline{x} ( {λ}_{i} ) {C}_{n , m} ( {λ}_{i} )}$$

$${Y}_{n , m} = {kG}_{n , m} \frac{{\sum }_{i = 400}^{700} s ( {λ}_{i} ) I ( {λ}_{i} ) \overline{y} ( {λ}_{i} )}{{\sum }_{i = 400}^{700} s ( {λ}_{i} ) \overline{I ( {λ}_{i} ) y} ( {λ}_{i} ) {C}_{n , m} ( {λ}_{i} )}$$

$${Z}_{n , m} = {kB}_{n , m} \frac{{\sum }_{i = 400}^{700} s ( {λ}_{i} ) I ( {λ}_{i} ) \overline{z} ( {λ}_{i} )}{{\sum }_{i = 400}^{700} s ( {λ}_{i} ) I ( {λ}_{i} ) \overline{z} ( {λ}_{i} ) {C}_{n , m} ( {λ}_{i} )}$$

The following applies to k:

$$k = \frac{100}{{\sum }_{400}^{700} \frac{I ( λ )}{L ( λ )} \overline{x} ( λ )}$$

I (I) denotes the wavelength-dependent relative intensity of a standardized illuminant type. L (I) denotes the wavelength-dependent intensity of the radiation device.

In a further process step, the area of this maximum is selected for evaluation of the absorption pigments and the value L*a*b is calculated and averaged for a sufficient number of pixels in this area. As mentioned above, this procedure can be used to identify areas of the image that reproduce flakes and areas that do not reproduce flakes.

To evaluate the flakes or the layer containing the flakes, separate flakes are preferably selected, as mentioned above. For example, a specific area of pixels can be assigned to a flake.

FIG. 9 shows the areas of the histogram that represent the absorption pigments and the areas that represent the effect pigments

FIGS. 10 to 13 show different images of surfaces. FIG. 10 shows a silver-metallic surface recorded at an angle of 15°, while FIG. 11 shows the same surface recorded at an angle of 80°. Significant differences can be seen in the two images. FIG. 12 shows a hyper red-metallic layer recorded at 15° and FIG. 13 shows a hyper red-metallic layer at 80°. Here, too, you can see considerable differences in the image recording. In particular, it can be seen that the influence of the effect pigments is much less noticeable at the 80° angle than in the images taken at 15°.

FIGS. 14 to 17 show RGB camera images of crystal silver xirallic coatings at 15° and 80°, with black as the absorption pigment base color (FIGS. 15 and 17) and white as the absorption pigment base color (FIGS. 16 and 18). It can be seen here that at 15° the effect pigments clearly stand out, whereas they have no effect or virtually no effect at all in the images taken at 80°. As mentioned above, one aspect of the invention is to adapt the image recording device to the characteristics of the human eye. However, this poses numerous problems. First of all, there are a plurality of filter curves that vary in relation to each other. The manufacture of LEDs also results in significant differences in the image recording characteristics.

A further problem is the temperature-dependent change in light-emitting diodes and their radiation activity.

RGB filters also diverge from camera to camera.

Newly designed filters are therefore required if a camera chip or the LED curves change. Care should be taken to have only a standard lighting and a standard observation device. In addition, the consistency between different observation devices or apparatuses is also a problem.

FIG. 18 shows a more detailed view of a hyper red metallic coating recorded at 80°. A few effect pigments can still be recognized here, which stand out.

FIG. 19 shows a representation in which the RBG values above the maximum of the histogram, which are to be assigned to the correctly oriented effect pigments, were set to the maximum values. It can be seen that the correctly oriented effect pigments no longer appear or are “subtracted out” in this representation. Only the misoriented effect pigments can still be recognized.

FIG. 20 shows a further processing of the image data, based on the data of FIG. 20, in which the RBG values below the maximum of the histogram, which are to be assigned to the misoriented effect pigments, were set to the maximum values. It can be seen that the misoriented effect pigments no longer appear or are “subtracted out” in this representation.

FIG. 21 shows hyper red histograms of the three channels (RGB). The individual curves are labeled.

The calibration of each individual pixel is described below. In the xyz color space, the following relationships result for x, y and z:

$$X = \frac{K}{N} {\int }_{400}^{700} S ( λ ) I ( λ ) \overline{x} ( λ ) d λ$$

$$Y = \frac{K}{N} {\int }_{400}^{700} S ( λ ) I ( λ ) \overline{y} ( λ ) d λ$$

$$Z = \frac{K}{N} {\int }_{40}^{700} S ( λ ) I ( λ ) \overline{z} ( λ ) d λ$$

The following applies:

$$N = {\int }_{400}^{700} I ( λ ) \overline{y} ( λ ) d λ$$

And k=1 or 100. S(λ) comes from color measurements at 110°

The following relationships apply to the values of an RGB camera

$$\overline{R} = {k}_{R} {\int }_{40}^{700} S ( λ ) {I}_{Led} ( λ ) {\overline{x}}_{R} ( λ ) d λ$$

$$\overline{G} = {k}_{G} {\int }_{400}^{700} S ( λ ) {I}_{Led} ( λ ) {\overline{y}}_{G} ( λ ) d λ$$

$$\overline{\overline{B}} = {k}_{B} {\int }_{400}^{700} S ( λ ) {I}_{Led} ( λ ) {\overline{z}}_{B} ( λ ) d λ$$

As part of the calibration, the illumination spectrum I_{Led}(λ) can be determined from color corrections. The values x̅_{R}(λ), y_{g}(λ) and z̅_{B}(λ) originate from sensitivity calibrations. For example, a calibration can preferably be performed on a white surface with a known spectrum S_{white}(I). This results in the following relationship for the values KR:

$${k}_{R} = \frac{R}{{\int }_{400}^{700} {S}_{white} ( λ ) {I}_{Led} ( λ ) {\overline{x}}_{R} ( λ ) d λ}$$

Corresponding relationships result for k_{G} and k_{B}.

L*, a* and b* can now be calculated for each individual pixel (using hyperspectral imaging):

$$X = R \times \frac{K}{N} \times \frac{{\int }_{400}^{700} S ( λ ) I ( λ ) \overline{x} ( λ ) d λ}{{k}_{R} {\int }_{400}^{700} S ( λ ) {I}_{Led} ( λ ) {\overline{x}}_{R} ( λ ) d λ}$$

$$Y = G \times \frac{K}{N} \times \frac{{\int }_{40}^{700} S ( λ ) I ( λ ) \overline{y} ( λ ) d λ}{{k}_{G} {\int }_{400}^{700} S ( λ ) {I}_{Led} ( λ ) {\overline{y}}_{G} ( λ ) d λ}$$

$$Z = B \times \frac{K}{N} \times \frac{{\int }_{40}^{700} S ( λ ) I ( λ ) \overline{z} ( λ ) d λ}{{k}_{B} {\int }_{400}^{700} S ( λ ) {I}_{Led} ( λ ) {\overline{z}}_{B} ( λ ) d λ}$$

The following applies:

$$N = {\int }_{400}^{700} I ( λ ) \overline{y} ( λ ) d λ$$

And k=1 or 100. S(λ) comes from color measurements at 110°

This results in L*, a* and b*

FIG. 22 again shows the TRI stimulus values plotted against the wavelength.

FIG. 23 shows the z_{B}, y_{G} and x_{R} values shown above.

FIG. 24 shows the sensitivity of the spectrometer, which is also taken into account.

To determine the parameters of the entire system for each individual pixel, it is proposed that a diffuse sphere is illuminated with a monochromatic light with a half-value wavelength of 10 nm, from 400 nm to 700 nm in steps of 10 nm.

The sphere has a measurement input and an external spectrometer. Furthermore, a plurality of images with a specific resolution, e.g. between 25 and 35 images with a resolution of 5 MP each, are recorded at different wavelengths in order to cover the visible spectral range.

The spectral sensitivity of all 5 million pixels is then preferably calculated.

For temperature calibration, the spectral distribution of the light-emitting diodes is recorded at different temperatures from 10 °C to 40 °C, preferably in a climatic chamber.

This results in the diagram shown in FIG. 24. This shows the measured sensitivity curves of the individual RGB channels of the camera sensor.

The result is a smaller variation from pixel to pixel of the spectral sensitivity curves, as indicated by the individual bars. This results in a total of three average sensitivity curves for each RGB channel, which fully represent or evaluate a specific RGB camera chip.

If the actual physical parameters of the LEDs, the filter and the camera are known, there are numerous advantages.

Firstly, you can compensate for the variation of the LED, SPD from different manufacturers. Filter variations can also be compensated. Furthermore, variations with regard to the camera can also be compensated, making it possible to replace the camera in a measurement setup.

Furthermore, the actual calibration of the entire system is also possible.

Different standard lighting can also be calculated.

In addition, this adjustment between different measuring devices is also improved. Finally, an LED temperature deviation is also taken into account.

A review of this method is described below.

In this method, a sufficient quantity of a known effect solution without effect pigments is mixed. This quantity is then divided into two (in particular equal) parts or two (in particular equal) containers. In a further step, the effect pigments are added to one of the two containers, in particular in the correct proportion.

There are now two color mixtures that are identical except for the addition of effect pigment to one of the two parts

These facts are in FIGS. 25 and 26.

Furthermore, the two mixtures with the same application parameters are preferably sprayed onto two test surfaces. If these two test surfaces are now measured with an integral non-spatially resolved spectrophotometer, there is a clear deviation in the color tone, which is expressed by the dE* 3.78 and confirms what can also be observed directly with the eye. The addition of effect pigment not only leads to the desired sparkle effect, but also changes the overall color impression of the sample.

In the further method, the absorption pigments are measured equally in the formulation with or without effect pigments using an RGB camera. FIG. 27 shows a corresponding curve, wherein the measurement is carried out at 80° with and without effect pigments. Both curves are labeled in each case.

FIG. 28 shows a corresponding RGB histogram for hyperred.

In the following table, the values L*, a* and b* were calculated from integral color measurements based on the spectral data at an angle of 110°:

| | L* | a* | b* | |
|---|---|---|---|---|
| Hyper red with | 17.05 | 37.92 | 25.22 | |
| effect | | | | |
| hyper red | 17.74 | 41.30 | 27.10 | dE* 3.78 |
| without effect | | | | |

In the following table, the values L*, a* and b* were calculated from the RGB camera image data when illuminated with an 80° LED.

| | L* | a* | b* | |
|---|---|---|---|---|
| Hyper red with | 17.56 | 40.94 | 26.89 | |
| effect | | | | |
| hyper red | 17.63 | 41.36 | 26.77 | dE* 0.44 |
| without effect | | | | |

In this way, the influence of effect pigments can be eliminated, which helps to measure the color of the absorption pigment essentially independently of the concentration of the effect pigments. This is demonstrated by the fact that the deviation of the measurement between the two samples “Hyperred with effect” and “Hyperred without effect” is only dE*=0.44 instead of dE* of 3.78.

More precisely, the influences of the effect pigments can be sorted out by comparison in order to determine the absorption pigment color as far as possible independently of the effect pigment concentration. The same calculations can also be carried out for the color mamba green, as in FIGS. 29 and 30.

FIG. 31 shows an image of a hyper-red surface with a fingerprint and FIG. 32 shows an image of a hyper-red surface with a scratch. In the following, it is suggested that these also be discarded.

This results in the following values for a flawless surface, a scratch and a fingerprint.

Integral color measurement at 110°:

| | L* | a* | b* | dE* |
|---|---|---|---|---|
| Hyper red, 15°, | 41.58 | 50.17 | 41.30 | |
| flawless | | | | |
| Hyper red, 15°, | 42.54 | 48.79 | 38.73 | 3.07 |
| with scratch | | | | |
| hyper red 15° | 48.44 | 44.06 | 30.07 | 14.51 |
| with fingerprint | | | | |

Camera-based measurement of the background color at 80°:

| | L* | a* | b* | dE* |
|---|---|---|---|---|
| Hyper red, | 16.82 | 45.76 | 25.83 | |
| flawless | | | | |
| Hyper red, with | 16.88 | 46.56 | 25.45 | 0.89 |
| scratches | | | | |
| hyper red with | 16.82 | 45.76 | 25.83 | 0.24 |
| fingerprint | | | | |

FIG. 33 shows a corresponding image of these three surfaces, wherein the differences can be seen particularly in a range from 640 nm.

Corresponding measurements are also determined for camera-based measurements of the background color. Here, too, the influences of a fingerprint and a scratch can be recognized.

FIG. 35 shows the corresponding RGB histograms of the three cases shown spectrally in FIG. 34: intact sample, with scratch and with fingerprint

In this way, it is possible to clearly identify dirt-induced data (such as scratches, fingerprints and the like) in an RGB camera histogram and eliminate them accordingly.

FIGS. 35-37 show three different measuring arrangements. In the measuring arrangement shown in FIG. 35, illumination is at +65°, i.e. starting from a direction perpendicular to the surface at an angle of 65° (counterclockwise)

Reflection occurs accordingly at an angle of −65°. The color is captured at an angle of +45 and therefore at an angle of 110° to the reflected radiation.

In the measuring arrangement shown in FIG. 36, the irradiation again takes place at +65°, but the observation by a RGB image camera takes place at +15 and thus at an angle of 80° to the reflected radiation.

In the measuring arrangement shown in FIG. 37, illumination can be carried out either at three angles, namely at +65°, but also at 0° and at −30°. The color detection is carried out here again at +45°. The dashed lines at +30°, 0° and −65° show in each case the reflected beam paths of the individual illuminations. It can be seen that measurements can be taken at a plurality of different angles in this way, depending on which lighting is activated.

The applicant reserves the right to claim all features disclosed in the application documents as being essential to the invention, provided that they are new, either individually or in combination, compared with the prior art. It should also be noted that the individual figures also describe features which may be advantageous in themselves. The person skilled in the art will immediately recognize that a certain feature described in a figure can also be advantageous without the adoption of further features from this figure. Furthermore, the person skilled in the art recognizes that advantages can also result from a combination of several features shown in individual figures or in different figures.

1. A method for inspecting lacquered surfaces which preferably have one or more layers with absorption pigments and/or effect pigments, wherein radiation being irradiated onto a surface to be inspected at a first predetermined angle of incidence by a first radiation device, and wherein a color image recording device recording a spatially resolved image of the surface irradiated by the direction of incidence at a first observation angle, wherein this image recording device having a first predetermined sensitivity which is dependent on a wavelength of the radiation impinging on the image recording device,
wherein
an image evaluation device carries out a section-by-section and preferably pixel-by-pixel evaluation of the image recorded by the image recording device, wherein the color image recording device also being used for evaluating and/or assessing the absorption and/or effect pigments, and/or the influence of effect pigments on the image recording and/or the integral color measurement being taken into account and/or eliminated as part of the image evaluation.

2. The method according to claim 1,
wherein
a classification of absorption and/or effect pigments is carried out with respect to at least one property characteristic of these absorption and/or effect pigments.

3. The method according to claim 2,
wherein
a cluster formation is carried out.

4. The method according to claim 3,
wherein
the characteristic property is selected from a group of properties consisting of a pigment size, a* values and b* values.

5. The method according to claim 1, wherein
a distinction is made in the evaluation with regard to absorption pigments and effect pigments.

6. The method according to claim 1, wherein
the influences of at least some of the absorption and/or effect pigments are eliminated.

7. The method according to claim 1, wherein
interfering features located on the surface are identified and preferably surface regions with such interfering features are disregarded in the evaluation.

8. The method according to claim 1, wherein
the wavelength-dependent sensitivity of the image recording device is determined by a spectrometer and/or a monochromator and/or the evaluation of the image recorded by the image recording device is carried out by a spectrometer and/or a monochromator.

9. The method according to claim 1, wherein
a sensitivity of the human eye which is dependent on a wavelength of the radiation incident on the human eye is taken into account in the evaluation.

10. The method according to claim 1, wherein
radiation is irradiated onto the surface at a second predetermined angle of incidence by a second radiation device and the image recording device records an image of the surface irradiated by the second radiation device.

11. The method according to claim 1, wherein
the observation angle relative to a direction perpendicular to the surface is less than 10°, preferably less than 5°, preferably less than 3°, and/or in that the first angle of incidence relative to a direction perpendicular to the surface is between 70° and 20°, preferably between 60° and 30°, preferably between 50° and 40°.

12. An apparatus for inspecting lacquered surfaces, preferably having one or more layers with absorption pigments and/or effect pigments, having a first radiation device configured to irradiate radiation onto a surface to be inspected at a first predetermined angle of incidence, and a color image recording device configured to record a spatially resolved image of the surface irradiated by the direction of incidence at a first observation angle, wherein this image recording device has a first predetermined sensitivity which is dependent on a wavelength of the radiation incident on the image recording device,
wherein
the apparatus has an image evaluation device configured to carry out a section-by-section and preferably pixel-by-pixel evaluation of the image recorded by the image recording device, wherein the color image recording device is also configured for evaluating and/or assessing the absorption and/or effect pigments, and/or the image evaluation is configured to take into account and/or eliminating the influence of effect pigments on the image recording and/or the integral color measurement.

13. The apparatus according to claim 12,
wherein
the apparatus has a calibration device which is configured for calibrating each individual pixel.

14. The apparatus according to claim 12, wherein
the filter device is configured to perform a pixel-by-pixel calibration of the values or signals output by the individual pixels of the color image recording device.

15. The apparatus according to claim 13, wherein
the filter device is configured to perform a pixel-by-pixel calibration of the values or signals output by the individual pixels of the color image recording device.

16. The method according to claim 2, wherein
a distinction is made in the evaluation with regard to absorption pigments and effect pigments.

17. The method according to claim 2, wherein
the influences of at least some of the absorption and/or effect pigments are eliminated.

18. The method according to claim 2, wherein
interfering features located on the surface are identified and preferably surface regions with such interfering features are disregarded in the evaluation.

19. The method according to claim 2, wherein
the wavelength-dependent sensitivity of the image recording device is determined by a spectrometer and/or a monochromator and/or the evaluation of the image recorded by the image recording device is carried out by a spectrometer and/or a monochromator.

20. The method according to claim 2, wherein
a sensitivity of the human eye which is dependent on a wavelength of the radiation incident on the human eye is taken into account in the evaluation.
